(19) United States
(12) Patent Application Publication
(10) Pub. No.: US 2011/0080460 A1
(43) Pub. Date: Apr. 7, 2011

(54) Open propagation service platform using video call and service method thereof

(76) Inventor: Chun-Sheng Chen, Taipei City (TW)

(21) Appl. No.: 12/659,046

(22) Filed: Feb. 24, 2010

(30) Foreign Application Priority Data
Oct. 1, 2009 (TW) 098133381

(51) Int. Cl. H04N 7/14

(52) U.S. Cl. 348/14.12; 348/E07.077

(57) ABSTRACT

An open propagation service platform using a video call and a service method thereof are described. The open propagation service platform includes an information service providing side, a service platform, and a video call service network. The information service providing side is used for providing various types of information. The service platform includes a data receiving and storing module for receiving and storing the information provided by the information service providing side, a data transmission module for transmitting the information in the data receiving and storing module, and a microprocessor for managing the service platform. The video call service network is connected with the service platform and provides a specific telephone number, so as to enable a user side to enter the service platform through the video call service network when dialing the telephone number using a video call, and receive and read the information transmitted by the data transmission module in the service platform.

### BACKGROUND OF THE INVENTION

1. Field of Invention

The present invention relates to an open propagation service platform using a video call and a service method thereof, and more particularly to an open propagation service platform that enables a user side to access various video information services after dialing a specific telephone number through a video call and is applicable to various users of the video call.

2. Related Art

Along with the advent of Internet era, the World Wide Web has been vigorously developed, and due to the continuous progress and enhancement of various technologies of the network, original monotonic and boring text web pages mainly providing information contents in the past have been transformed into interactive web pages or websites presented by various multimedia technologies. Moreover, the development of the technology also results in more interaction between users and web pages or websites.

Since users can obtain various real-time and latest messages through the network at any time under the vigorous development of the Internet applications, in order to meet their demands, Internet players aim to enable the users to watch or download various types of programs such as news, music, films, and plays at any time through platforms such as Web televisions (Web-TVs), Internet Protocol televisions (IPTVs), video sharing websites, or video download websites, such that the transmission over the network is no longer restricted to propagation of text messages only.

However, among the above service platforms, Web-TVs and IPTVs are not open to all long tail content provider; according to the 80/20 theory of the statistics, the service scope of the service platforms is limited to only 20% for short head supply-demand relationships. While video sharing and download websites are of the sharing property without specific supply-demand relationships, and the application scope thereof is limited to free services only, in general.

In addition, the Internet application service network is boundless, which brings people convenience and welfare as well as concealed worries and potential crises. At present, the convenience of anonymity falls into an umbrella under which evildoers perform illegal acts such as phone scam/obtaining property by threats. In the long term, since the main business model of large portal website leaders is to accumulate popularity (worldwide) with free service and then attract (worldwide) advertisements to make profit, the concealed worry resulting there-from is the service value transfer. Such phenomenon that the value is transferred from the service itself to advertisements and the transfer scope is increasingly expanded will lead to a road of no return that large websites remain large constantly and become extremely dominating.

Further, with the advent of 3G era, video call is regarded by telecommunication service providers and end users as a brand-new personalized service in the future. The video call enables users to carry out voice conversation with more intimate interaction in the call. However, the video call is already not new in terms of scientific technology. In the past era of fixed network, people had tried to make two sides of a call see each other. Thus, the video call is only a fresh taste for consumers without absolute necessity. Therefore, the pure voice communication is still a most primitive but most important source of income in the current income of communications service providers.

In view of the above, how to create the win-win situation for the supply side and the user side by effectively using the popularity and convenience of the video call has been the direction of the research of the present inventor.

### SUMMARY OF THE INVENTION

Accordingly, the present invention is directed to an open propagation service platform using a video call and a service method thereof, for enabling the access to various video information services after a specific telephone number is dialed through a video call.

The present invention is further directed to an open propagation service platform using a video call and a service method thereof, for increasing services and income of video call operators and meeting various application demands of video call users.

Accordingly, the present invention provides an open propagation service platform using a video call and a service method thereof. Specifically, the open propagation service platform using a video call includes an information service providing side, a service platform, and a video call service network. The information service providing side is used for providing various types of information. The service platform includes a data receiving and storing module for receiving and storing the information provided by the information service providing side, a data transmission module for transmitting the information in the data receiving and storing module, and a microprocessor for managing the service platform. The video call service network is connected with the service platform and provides a specific telephone numbering plan, so as to enable at least one user side to enter the service platform through the video call service network when dialing the telephone number using the video call, and receive and read the information transmitted by the data transmission module in the service platform on a video call of the user side.

In the implementation, the various types of information provided by the information service providing side include real-time and non real-time video propagation services, advertising information, and video information portal services.

In the implementation, the telephone number provided by the video call service network is a telephone number having a charging mechanism.

In the implementation, the information service providing side includes at least one video service provider for providing various types of information.

In the implementation, the information service providing side includes operation modes such as video service shelving, direct function setting, push list creation and content setting, and periodic service income and expenditure settlement.

In the implementation, the video call can be made through a cell phone, a computer such as a personal computer (PC)/note book (NB) having a soft phone, a TV (serving as a PC/NB display screen, an IPTV having a soft phone), and other digital terminal equipment.

In order to make the present invention more comprehensible, an embodiment is described in detail below.

### BRIEF DESCRIPTION OF THE DRAWINGS

The present invention will become more fully understood from the detailed description given herein below for illustration only, and thus are not limitative of the present invention, and wherein:

FIG. 1 is a main architectural view of an open propagation service platform using a video call according to an embodiment of the present invention;

FIG. 2 is a detailed architectural view of the open propagation service platform using the video call according to the embodiment of the present invention; and

FIG. 3 is a flow chart of an application method of the present invention.

### DETAILED DESCRIPTION OF THE INVENTION

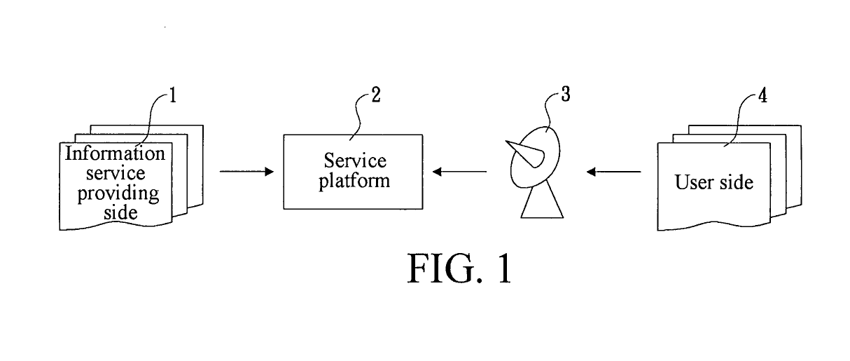

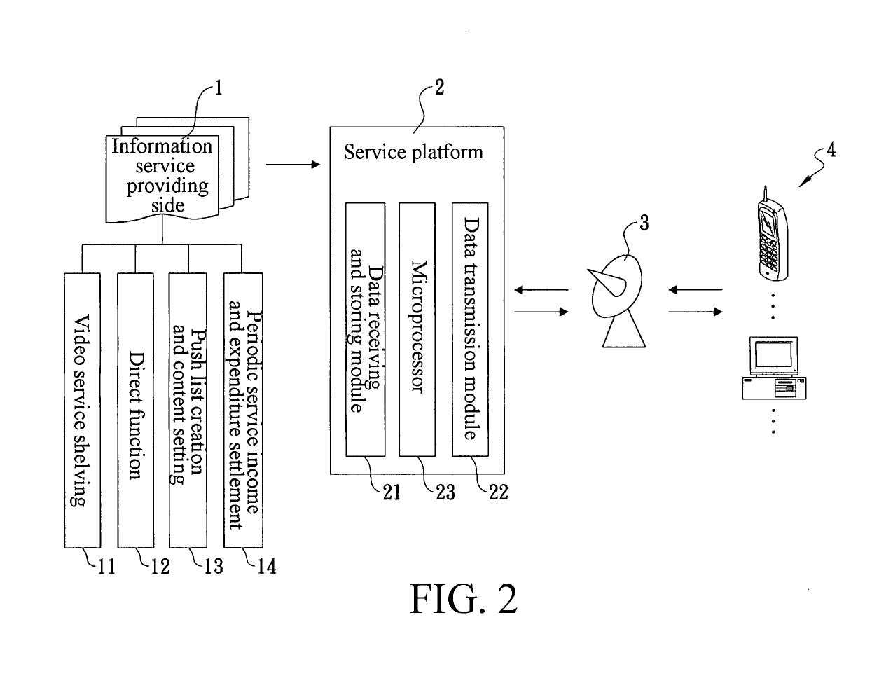

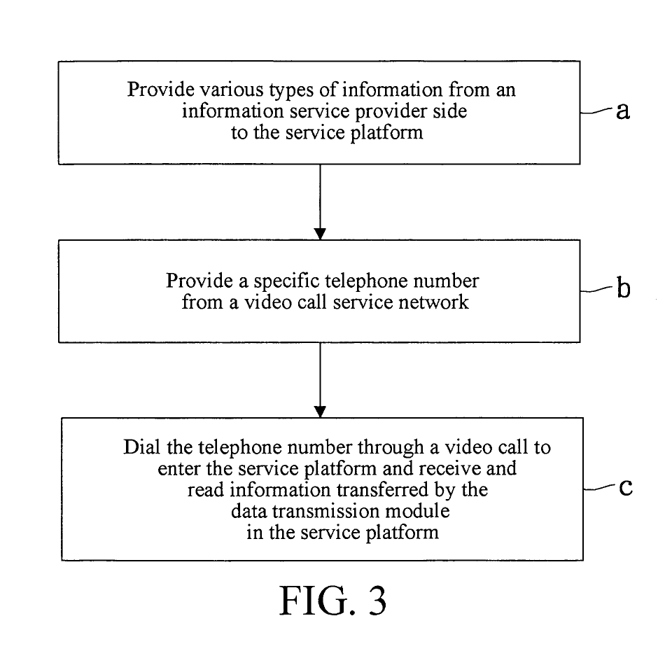

Referring to FIGS. 1-3, an embodiment of an open propagation service platform using a video call and a service method thereof in the present invention is shown. The open propagation service platform using a video call mainly includes an information service providing side 1, a service platform 2, and a video call service network 3.

The information service providing side 1 includes at least one video service provider for providing various types of information, and may also provide various types of information to the service platform 2 through a video call for live applications and shelving mechanism for non-live applications. The various types of information may include real-time or non real-time video propagation services, advertising information, video information portal services, or the like. The information service providing side 1 includes operation modes such as video service shelving 11, direct function setting 12, push list creation and content setting 13, and periodic service income and expenditure settlement 14. The service platform 2 includes a data receiving and storing module 21 for receiving and storing the information provided by the information service providing side 1, a data transmission module 22 for transmitting the information in the data receiving and storing module 21, and a microprocessor 23 for managing the service platform 2. The video call service network 3 is connected with the service platform 2 and provides a specific telephone numbering plan. The telephone numbering plan is a telephone numbering plan having a charging mechanism. The video call can be made through a cell phone, a computer such as a PC/NB having a soft phone, a TV (serving as a PC/NB display screen, an IPTV having a soft phone), and other digital terminal equipment.

The service method in the present invention includes the following steps.

In step a, various types of information is provided from an information service provider side to the service platform.

In step b, a specific telephone number is provided from the video call service network.

In step c, the telephone number is dialed through a video call to enter the service platform and receive and read information transferred by the data transmission module in the service platform.

Therefore, in the implementation, when the video service provider shelves various types of information to be provided on the service platform 2 from the information service providing side 1, a user side 4 can be connected to the service platform 2 after dialing the specific telephone number through a cell phone, a computer, or other terminal equipment, and a consumer at the user side 4 can view and query information on the terminal equipment. The following implementation case is given hereby. The video service provider may provide real-time video service commodities, for example, live broadcast of concerts or ball games, on the service platform. Thus, after dialing the specific telephone number of the video service provider, one or more consumers can enter a service menu set by the video service provider on the service platform through the video call service network and select the live broadcast of concerts or ball games through the service menu, so as to immediately receive and watch the broadcast on a cell phone or computer through a video call. Certainly, the reception and watching is charged by a charging method for video call of the video call service network. The consumer can receive and watch the broadcast easily at any time and in anywhere by paying the call charge (including no charge).

Therefore, the present invention has the following advantages.

1. The present invention provides a brand-new video propagation network using a video call as a terminal carrier. Each telephone number can become a video channel. After a service platform operator approves the application for video propagation services, the video service provider can shelve video service contents or shelve the contents in a real-time video (live) manner, so as to provide video services. Compared with the existing TV service network (including broadcasting TV, cable TV, IPTV, etc.), video service providers of the open service platform may also be long tail merchants (common people) in the network era, so it completely agrees with characteristics of the development of the network economy, conforms to the government's administrative policies for developing the common people economy, and is further a sharp tool for serving the people with technology and supporting the domestic video content industry with science and technology to expand the market.

2. The present invention helps network phone operators to create the video propagation platform service and improve the income; and may be combined with mechanisms of user account number of the network phone operators and match various call rates so as to meet various application demands and provide services rapidly.

3. The present invention helps network phone operators to achieve the goal of rapid user subscription development.

4. The open propagation service platform using a video call in the present invention has advantages such as ad hoc service provisioning, flexibility of live/push/on demand service modes, various video qualities/formats, and flexible charging at the supply side, and has advantages such as ad hoc, live/on demand/group cast, and mobility convenience of various terminal carriers at the demand side.

Thereby, the present invention provides an open propagation service platform using a video call and a service method thereof. The service platform may construct a brand-new video service network, create the video application service ecosystem, and provide infinite business opportunities for blue ocean application services. In terms of application, it serves and benefits the people with science and technology; and in terms of technology, a video call terminal is combined with the innovation of the open video service platform, so as to create an open video application service network different from the Internet application service network. With this open video application service network, most of supply-demand relationships in the real life that are difficult to be realized on the Internet application service network and various TV service networks may be realized. In addition, the platform may provide more opportunities for innovation application with video call related technologies. On the other hand, the brand-new video service network created in the open propagation service platform in the present invention is constructed on a local (domestic) video call service network, and is a hotbed for realizing many long tail supply-demand relationships and sprouting and developing various blue ocean application services. In this way, the common people economy can be developed, and domestic industries can be supported to expand their domestic/foreign services.

The above descriptions are a specific embodiment and technical means thereof in the present invention. Many variations and modifications may be derived from the disclosure or teachings of the present invention. Any equivalent changes made according to the concept of the invention and functioning without departing from the essential spirit of the specification and drawings should fall within the technical scope of the present invention.

According to the above disclosures, the present invention can indeed achieve the expected objectives to provide an open propagation service platform using a video call and a service method thereof, and has industrial applicability and practicability undoubtedly. Thus, an invention patent application is filed according to the law.

What is claimed is:

1. An open propagation service platform using a video call, comprising:
an information service providing side, for providing various types of information;
a service platform, comprising:
a data receiving and storing module, for receiving and storing the information provided by the information service providing side;
a data transmission module, for transmitting the information in the data receiving and storing module; and
a microprocessor, for managing the service platform; and
a video call service network, connected with the service platform, for providing a specific telephone number, so as to enable at least one user side to enter the service platform through the video call service network when dialing the telephone number using the video call, and receive and read the information transferred by the data transmission module in the service platform on a video call of the user side.

2. The open propagation service platform using a video call according to claim 1, wherein the video call is made through a cell phone, a computer including a personal computer (PC)/note book (NB) having a soft phone, a television (serving as a PC/NB display screen, an Internet Protocol television (IPTV) having a soft phone), and other digital terminal equipment.

3. The open propagation service platform using a video call according to claim 1, wherein the various types of information provided by the information service providing side comprise real-time or non real-time video propagation services, advertising information, or video information portal services.

4. The open propagation service platform using a video call according to claim 1, wherein the telephone number provided by the video call service network is a telephone number having a charging mechanism.

5. The open propagation service platform using a video call according to claim 1, wherein the information service providing side comprises at least one video service provider for providing various types of information.

6. The open propagation service platform using a video call according to claim 1, wherein the information service providing side comprises operation modes including video service shelving, director function setting, push list creation and content setting, and periodic service income and expenditure settlement.

7. The open propagation service platform using a video call according to claim 1, wherein the information service providing side is capable of providing various types of information to the service platform through a video call.

8. A service method of an open propagation service platform using a video call, wherein the service platform comprises:
a data receiving and storing module, for receiving and storing information provided by an information service providing side;
a data transmission module, for transmitting the information in the data receiving and storing module; and
a microprocessor, for managing the service platform,
the method comprising:
a: providing various types of information from an information service provider side to the service platform;
b: providing a specific telephone number from a video call service network; and
c: dialing the telephone number through a video call, so as to enter the service platform and receive and read the information transferred by the data transmission module in the service platform.

9. The service method of an open propagation service platform using a video call according to claim 8, wherein the various types of information provided by the information service providing side comprise real-time or non real-time video propagation services, advertising information, or video information portal services.

10. The service method of an open propagation service platform using a video call according to claim 8, wherein the telephone number provided by the video call service network is a telephone number having a charging mechanism.

11. The service method of an open propagation service platform using a video call according to claim 8, wherein the information service providing side comprises at least one video service provider for providing various types of information.

12. The service method of an open propagation service platform using a video call according to claim 8, wherein the information service providing side comprises operation modes including video service shelving, direct function setting, push list creation and content setting, and periodic service income and expenditure settlement.

13. The service method of an open propagation service platform using a video call according to claim 8, wherein the video call is made through a cell phone, a computer including a personal computer (PC)/note book (NB) (a soft phone), a television (serving as a PC/NB display screen, an Internet Protocol television (IPTV) having a soft phone), and other digital terminal equipment.
